(19) United States
(12) Patent Application Publication
(10) Pub. No.: US 2021/0314497 A1
(43) Pub. Date: Oct. 7, 2021

(54) Camera Monitoring System

(71) Applicant: KNORR-BREMSE Systeme fuer Nutzfahrzeuge GmbH, Muenchen (DE)

(72) Inventors: Huba NEMETH, Budapest (HU); Levente BALOGH, Szigetszentmiklos (HU); Viktor TIHANYI, Budapest (HU); Adam SZOELLOSI, Budapest (HU)

(21) Appl. No.: 17/266,348

(22) PCT Filed: Jul. 18, 2019
(86) PCT No.: PCT/EP2019/069417

§ 371 Date: Feb. 5, 2021

(30) Foreign Application Priority Data
Aug. 6, 2018 (DE) 10 2018 119 026.3

(51) Int. Cl. H04N 5/247; B60R 11/04; G06K 9/00; G06K 9/62; G06T 5/00; G06T 5/50

(52) U.S. Cl. CPC H04N 5/247; B60R 11/04; G06K 9/00798; G06T 2207/30256; G06T 5/006; G06T 5/50; G06K 9/6202

(57) ABSTRACT

A camera monitoring system for at least one lateral area on a passenger side of a commercial vehicle includes: a first image processing unit; a first camera unit for capturing image data from the at least one lateral area, wherein the first camera unit makes the image data available to the first image processing unit for processing; a second image processing unit; and a second camera unit for capturing further image data from the at least one lateral area. The second camera unit makes the further image data available to the second image processing unit for processing. The first image processing unit and the second image processing unit are designed to process image data independently of one another in order to allow redundant image capture for the at least one lateral area.

### BACKGROUND AND SUMMARY OF THE INVENTION

The present invention relates to a camera monitoring system and to a method for determining an error in a camera monitoring system and in particular to an error-resistant architecture for a camera system of commercial (utility) vehicles.

The continuous improvement of video sensor technology and visual display options permits known devices for indirect vision representation to be replaced increasingly in vehicles. Thus, instead of the traditional mirrors, camera monitoring or camera display systems are increasingly used, which replace the mirrors and enable a higher visual quality, additional functionality, for example zooming or overlaid representations on displays. A further motivation for using camera monitoring systems is that the cameras used are relatively small and thus reduce the air resistance. The rearview mirrors which are otherwise used offer a significant wind engagement area due to their size and thus cause a significantly higher fuel consumption.

Although the new technologies offer many possibilities, they are also subject to an array of new error sources. While in conventional rearview mirrors the visual quality can be impaired by broken glass or surface soiling, camera display systems comprise many components, which are accompanied by a variety of further error sources. The situation is furthermore made worse in that frequently an error in only one part of the system is sufficient to make the entire system nonfunctional, so that as a consequence it is no longer possible for the vehicle driver to register the rear area. Thus, for example, a power supply can fail or a software error can occur or an electrical contact can have a fault, in order to put the entire system out of operation.

It is therefore important that camera monitoring systems are equipped with a suitable error management system in order to still ensure, even if an error occurs, that the driver still receives items of information about the back or lateral area of the vehicle.

Known camera monitoring systems are described, for example in US 2017/282801, in US 2017/274827 A1, in EP 3 231 668 A1, and in US 2015/165975 A1. The systems described therein do permit the replacement of mirrors by cameras, but even in these systems a single error in a subsystem can result in a failure of the entire system. Such a failure is not critical in the passenger vehicle area to the same extent as in the utility vehicle area, since the driver of passenger vehicles can still visually register the lateral and rear areas. This is precluded in the utility vehicle area since a driver cannot visually register the passenger side, for example, if a mirror or an error-free camera system is not available.

There is therefore a need for a camera monitoring system which is suitable for utility vehicles and offers a high level of security, in order to be able to replace rearview mirrors with it.

At least a part of these problems is solved by a camera monitoring system, a commercial (utility) vehicle equipped with such a camera monitoring system, and a method, in accordance with the claimed invention.

The present invention relates to a camera monitoring system for at least one lateral area on a passenger side of a utility vehicle. The camera monitoring system comprises:
a first image processing unit;
a first camera unit for acquiring image data from the at least one lateral area, wherein the first camera unit provides the image data to the first image processing unit for processing;
a second image processing unit;
a second camera unit for acquiring further image data from the at least one lateral area, wherein the second camera unit provides the further image data to the second image processing unit for processing.

The first image processing unit and the second image processing unit are designed to process image data independently of one another and thus enable a redundant image acquisition for the at least one lateral area.

The camera monitoring system is in particular a camera display system, which is capable of replacing existing rearview mirrors on a utility vehicle. It is therefore designed in particular for a lateral image acquisition in order to visually acquire an environment of the vehicle. It is obvious that exemplary embodiments are not to be restricted to the application in utility vehicles. The camera monitoring system can also be used for other vehicles.

The camera monitoring system optionally comprises a third camera unit, which is designed to acquire image data from a further lateral area on a driver side of the utility vehicle. The third camera unit provides the image data to the first image processing unit for processing. The camera monitoring system optionally comprises a fourth camera unit, which is designed to acquire image data from the further lateral area on the driver side of the utility vehicle. The fourth camera unit provides the image data to the second image processing unit for processing. It is obvious that the third camera unit can also provide the image data to the second image processing unit and the fourth camera unit can also provide the image data to the first image processing unit.

The camera monitoring system optionally comprises a first display unit for displaying processed image data from the first image processing unit. The camera monitoring system can additionally comprise a second display unit for displaying processed image data from the second image processing unit.

The camera monitoring system optionally comprises a data connection between the first image processing unit and the second image processing unit, wherein the first image processing unit and the second image processing unit are designed to output received image data via the data connection. The image data can be exchanged permanently between the image processing units or only if a specific event is present (for example a determined error or on request).

The first image processing unit and/or the second image processing unit is optionally designed to compare image data from overlapping acquisition areas and, based thereon, to determine an error of the camera monitoring system. Upon the comparison, for example, deviations or frozen images or other unexpected artifacts can be determined. Upon the determination of an error, a warning can be output or image data from the defective image processing unit can be relayed to the intact image processing unit. The overlapping acquisition areas can be arbitrary areas from the environment of the utility vehicle (also comprising roadway markings), which were acquired by various camera units. To be able to compare overlapping areas, optionally an image transformation can be carried out first, for example to eliminate distortions of the objectives used (for example from a fisheye objective).

The first camera unit optionally comprises a wide-angle objective or a fisheye objective in order to simultaneously acquire a front area in front of the utility vehicle and the at least one lateral area on the passenger side upon attachment to a front corner area of the utility vehicle. The fourth camera unit can also include a wide-angle objective or fisheye objective in order to simultaneously acquire the front area and the lateral area on the driver side upon attachment to a front corner area of the utility vehicle. Moreover, the first image processing unit and/or the second image processing unit can be designed to carry out an image transformation of image data from the first camera unit and/or from the second camera unit, in order to reduce distortions in horizontal image areas (edge areas of the image). In this way, in the event of failure of the second camera unit or the third camera unit, a rear-facing image acquisition can be ensured by the first and/or fourth camera unit. The distortions at the outer edge of recordings using a fisheye objective are to be removed or alleviated using the image transformation, so that a driver can recognize objects. The first image processing unit and/or the second image processing unit can also be designed to identify roadway markings in the image data from the first camera unit and/or the second camera unit and/or the third camera unit and/or the fourth camera unit, for example, in order to assist lane tracking.

The first camera unit and the fourth camera unit are optionally each furthermore designed to acquire ground areas in front of an adjacent to the driver cab, in order to thus enable a redundant acquisition of the ground area in front of the driver cab. The ground areas (or sensor areas) represent areas on the ground which are acquirable by the cameras.

The lateral area (on the passenger side) and the further lateral area (on the driver side) on the respective side optionally comprise at least one first ground area defined as follows: Beginning with a first line, which extends perpendicularly to a movement direction of the utility vehicle and is offset by 4 m to the rear from a position of a vehicle driver (or his eye viewpoints), the first ground area extends to the rear with a variable width laterally parallel to a vehicle edge. The variable width increases linearly from 1 m to a width of 5 m up to a distance of 26 m from the first line and then remains constant.

The lateral area (on the passenger side) and the further lateral area (on the driver side) on the respective side optionally comprise at least one second ground area defined as follows: Beginning with a second line, which extends perpendicularly to a movement direction of the utility vehicle and is offset 1.5 m to the rear from a position of a vehicle driver, the second ground area extends with a variable width laterally parallel to a vehicle edge to a length of 23.5 m to the rear. The variable width increases linearly from 4.5 m to a width of 15 m up to a distance of 8.5 m from the second line and then remains constant.

The lateral area (on the passenger side) and the further lateral area (on the driver side) on the respective side optionally comprise at least one third ground area defined as follows: Beginning with a third line, which extends perpendicularly to a movement direction of the utility vehicle through a position of a vehicle driver, the third ground area extends 1.75 m to the rear and 1 m forward at a width of 2 m parallel to a vehicle edge.

The front area optionally comprises a fourth ground area defined as follows: Beginning with a front vehicle boundary, the fourth ground area extends up to at least 2 m in front of a total width of the driver cab and laterally 2 m beyond the passenger side. Optionally, the front corner is rounded on the laterally protruding section with a radius of curvature of 2 m.

The present invention also relates to a commercial (utility) vehicle having an above-described camera monitoring system.

The present invention also relates to a method for determining an error of a camera monitoring system. The method comprises the following steps:
comparing image data for overlapping image areas which were acquired by different camera units; and
determining an error in the camera monitoring system based on the comparison.

The comparison optionally comprises at least one of the following:
determining a non-correspondence of the overlapping image areas;
determining a frozen image which was acquired by one of the camera units;
transforming image data in order to reduce distortions from fisheye objectives or wide-angle objectives.

This method or at least parts thereof can also be implemented or stored in the form of instructions in software or on a computer program product, wherein stored instructions are capable of executing the steps according to the method when the method runs on a processor. The present invention therefore also relates to a computer program product having software code (software instructions) stored thereon, which is designed to execute one of the above-described methods when the software code is executed by a processing unit. The processing unit can be any form of computer or control unit which includes a corresponding microprocessor that can execute software code.

The problems mentioned at the outset are solved by exemplary embodiments by a camera monitoring system in which the first camera unit sends image data to the first image processing unit and the second camera unit sends image data to the second image processing unit, wherein the first image processing unit and the second image processing unit process image data independently of one another and provide these data to a display independently of one another. The first image processing unit and the second image processing unit can accordingly represent separate units which can be integrated into one unit, but do not mutually influence one another, so that the failure of one of the two image processing units has no negative effects on the other image processing unit. A data connection is advantageously provided between the first image processing unit and the second image processing unit which, at least in the event of failure of one of the two image processing units, is used to relay the image data to the respective intact image processing unit, so that the corresponding images can be displayed there. Exemplary embodiments therefore provide an error resistant and redundant system at least for the passenger side.

The exemplary embodiments of the present invention will be understood better from the following more detailed description and the appended drawings of the different exemplary embodiments, which are not to be understood, however, in such a way that they restrict the disclosure to the specific embodiments, but rather solely serve for explanation and comprehension.

### BRIEF DESCRIPTION OF THE DRAWINGS

FIG. 1 shows a camera monitoring system according to one exemplary embodiment of the present invention.

FIG. 2 shows further optional components of the camera monitoring system from FIG. 1.

FIGS. 3A,3B illustrate ground areas which are acquired simultaneously by the second camera unit according to exemplary embodiments.

FIGS. 4A,4B illustrate ground areas which are acquired simultaneously by the first camera unit according to exemplary embodiments.

FIGS. 5A,5B show a display for ground areas from FIGS. 3A, 3B.

FIGS. 6A,6B show a display for ground areas from FIGS. 4A, 4B.

FIGS. 7A,7B show a possible attachment of the camera units to a commercial (utility) vehicle according to further exemplary embodiments.

### DETAILED DESCRIPTION OF THE DRAWINGS

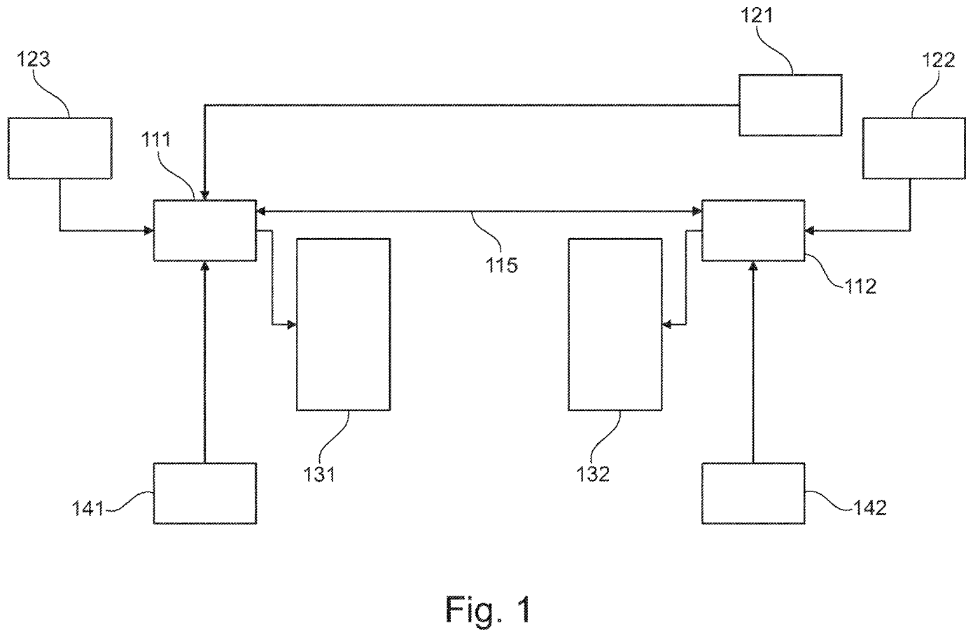

FIG. 1 shows a camera monitoring system according to one exemplary embodiment of the present invention. It is suitable for use in commercial (utility) vehicles and represents a redundant system in particular for the passenger side, in order to replace rearview mirrors provided there by way of the camera monitoring system. The camera monitoring system comprises a first image processing unit 111, a second image processing unit 112, a first camera unit 121, and a second camera unit 122. The first camera unit 121 sends image data to the first image processing unit 111. The second camera unit 122 sends image data to the second image processing unit 112.

The first camera unit 121 and the second camera unit 122 are designed to be attached in a front corner area or on a lateral area of the driver cab (for example on the passenger side) and to acquire the lateral or back area of the utility vehicle independently of one another. In particular, the first camera unit 121 acquires a ground area which directly adjoins the utility vehicle. In addition, the first camera unit 121 acquires the lateral area adjacent to or behind the driver cab. In order to achieve this, the first camera unit 121 can comprise a corresponding wide-angle objective, for example a fisheye objective. The second image processing unit 122 acquires a lateral and back area of the utility vehicle, wherein a simultaneous acquisition can take place. For this purpose, a corresponding wide-angle objective can again be provided.

The camera monitoring system from FIG. 1 optionally comprises a third camera unit 123, which is attachable to a driver side of the driver cab and, similarly to the second camera unit 122, acquires a lateral and a back area on the driver side. The corresponding image data can be sent to the first image processing unit 111 (alternatively also to the second image processing unit 112).

Furthermore, a first display unit 131 and a second display unit 132 are provided in the exemplary embodiment. The first display unit 131 can visually display the processed image data of the first image processing unit 111. The second display unit 132 can visually display the processed image data of the second image processing unit 112. For example, the first display unit 131 can be installed on a driver side in the driver cab and the second display unit 132 can be installed on a passenger side in the driver cab.

Furthermore, independent power supply units 141, 142 are provided in the exemplary embodiment. Thus, for example a first power supply unit 141 can be provided for the first image processing unit 111. A second power supply unit 142 can also be provided for the second image processing unit 112. In this way, the illustrated system is designed to be completely redundant, so that in the event of failure of a single subsystem (or a component), it is still ensured that the driver of the utility vehicle is capable of securely registering at least the passenger side.

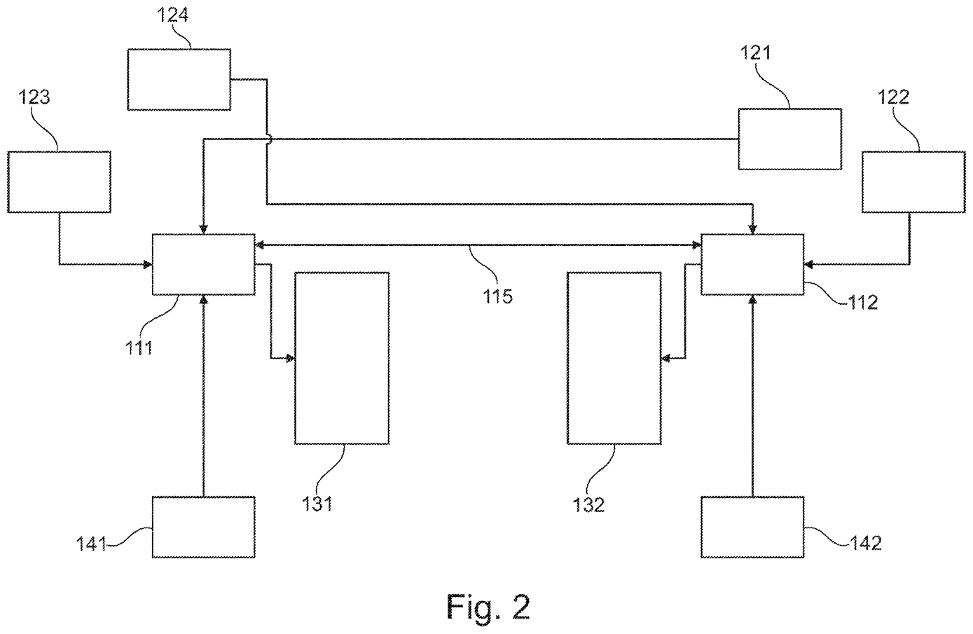

FIG. 2 shows a further exemplary embodiment of the camera monitoring system, which differs from the system shown in FIG. 1 in that a fourth camera unit 124 is provided, which is attachable on the driver side in a corner area of the driver cab and sends image data to the second image processing unit 112 for display. The fourth camera unit 123 can be designed similarly or identically to the first camera unit 121 and acquires a ground area which directly adjoins the utility vehicle. Moreover, the fourth camera unit 124 can acquire a lateral area adjacent to or behind the driver cab on the driver side. To achieve this, the fourth camera unit 124 can also comprise a corresponding wide-angle objective, for example a fisheye objective.

Since both the first camera unit 121 and also the fourth camera unit 124 are attachable at corresponding front corner areas of the driver cab and transmit their image data to different image processing units 111, 112, the exemplary fisheye objective also enables a redundant acquisition of the ground area in front of the driver cab.

The camera monitoring system from FIG. 2 thus comprises two parallel subsystems, which can be designed more or less identically and each include a separate image processing unit. The second image processing unit 112 thus receives image data both from the driver side (via the fourth camera unit 124) and also from the passenger side (via the second camera unit 122), which are visually displayed after the processing on the second display unit 132. In the same way, the first image processing unit 111 processes both image data from the driver side (via the third camera unit 123) and also image data from the passenger side (from the first camera unit 121) and visually displays the results on the first display unit 131. A completely redundant system is thus achieved both on the driver side and also on the passenger side and the area in front of the utility vehicle.

In the exemplary embodiments of FIG. 1 and FIG. 2, a data connection 115 is additionally provided between the first image processing unit 111 and the second image processing unit 112. The first image processing unit 111 and the second image processing unit 112 can be designed, for example, in case of an error to relay the image data which are normally processed by the corresponding image processing unit 111, 112 to the respective other image processing unit. The respective other image processing unit can then display the transferred data on the respective associated, correctly working display unit. The driver can optionally be informed about the erroneous behavior. A warning can be output for this purpose.

It is furthermore optionally possible that image data are transmitted continuously via the data connection 115 (also in a non-error case). In this case, the image data can be compared—at least for overlapping acquisition areas. Based on the comparison, it is possible to establish errors in the system (for example due to a frozen image). The images transmitted via the data connection 115 can also be displayed by the respective other display unit. The driver can also be informed about the error in this case.

According to exemplary embodiments, some or all camera units can comprise wide-angle objectives, wherein the first camera unit 121 and the fourth camera unit in particular include a fisheye objective. Thus, as already stated, various sensor areas and in particular ground areas around the vehicle can be acquired in parallel. Thus, for example, the second camera unit 122 can be designed to acquire a first and a second ground area laterally adjacent to or behind the utility vehicle. The first camera unit 121 can also be designed to acquire a third ground area laterally below the driver cab, and a fourth ground area in front of the driver cab.

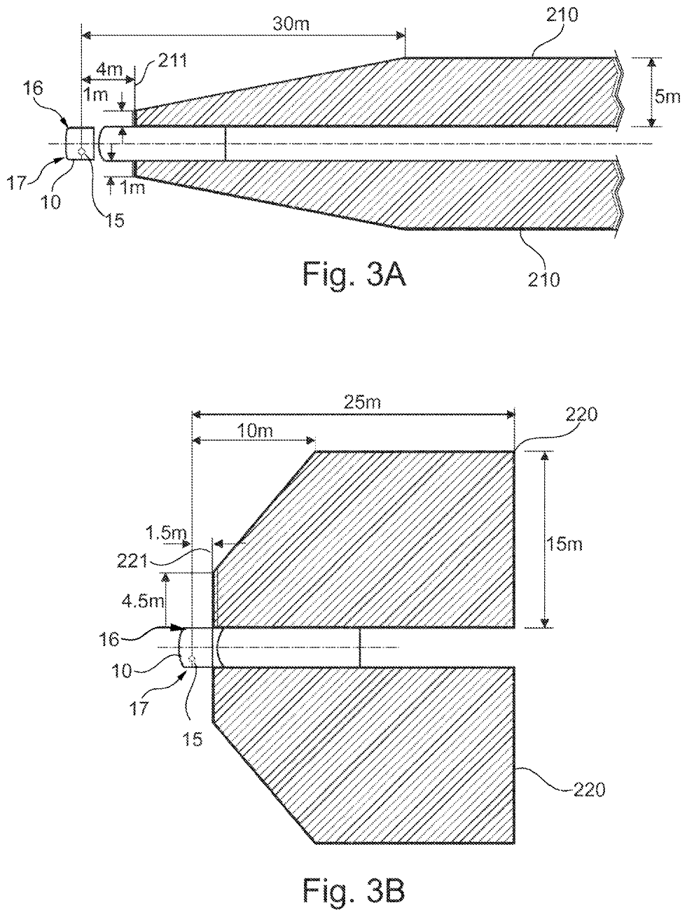

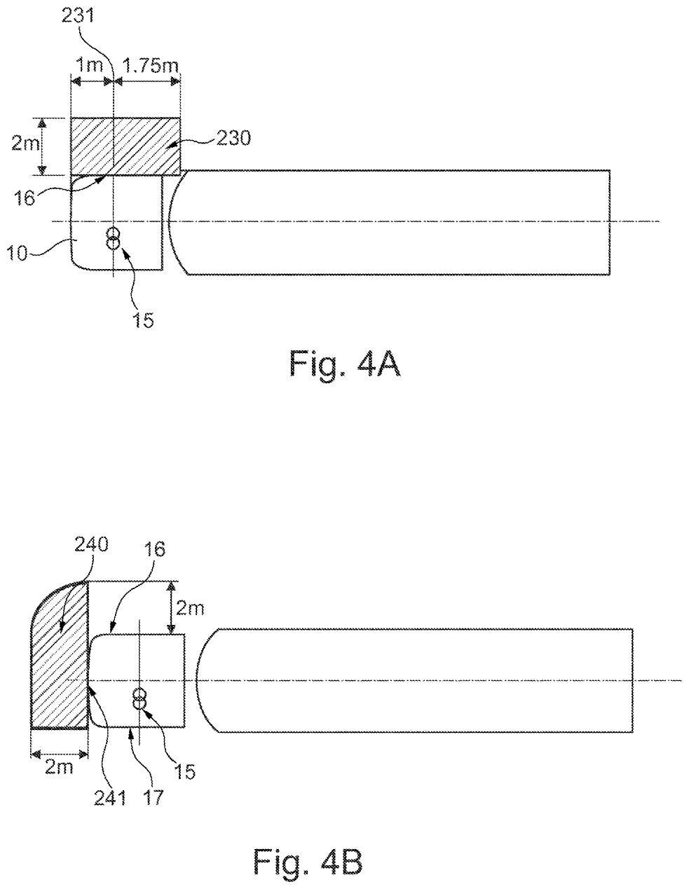

FIG. 3A, FIG. 3B, FIG. 4A and FIG. 4B illustrate the ground areas which are acquired simultaneously according to exemplary embodiments, for example by the camera units 121, 122, 123, 124 as lateral areas (or further lateral areas). Here and in the following, all length specifications are understood up to a tolerance of ±10% or ±5%. In addition, the following ground areas are minimal areas, which are at least acquired. It is obvious that the camera units additionally acquire further areas.

FIGS. 3A, 3B illustrate ground areas 210, 220, which are acquired simultaneously by the second camera unit according to exemplary embodiments.

FIG. 3A shows the first ground area 210, which extends on both sides of the vehicle and can be defined as follows: It begins with a first line 211, which extends perpendicularly to a movement direction of the utility vehicle and is offset to the rear by 4 m from a position 15 of a vehicle driver (or his eye viewpoints), and extends to the rear with a variable width laterally in parallel to both vehicle edges 16, 17. The variable width increases linearly from 1 m to a width of 5 m up to a distance of 26 m from the first line 211 and then remains constant. The first ground area 210 thus comprises a maximum width of approximately 5 m, wherein this maximum width is reached at a distance of approximately 30 m beginning with the driver position.

FIG. 3B shows the second ground area 220, which extends on both sides of the vehicle and can be defined as follows: The second ground area 220 begins with a second line 221, which extends perpendicularly to a movement direction of the utility vehicle and is offset to the rear by 1.5 m from a position 15 of a vehicle driver (or his eye viewpoints), and extends to the rear with a variable width laterally in parallel to the vehicle edges 16, 17 at a length of 23.5 m. The variable width increases linearly from 4.5 m to a width of 15 m up to a distance of 8.5 m from the second line 221 and then remains constant. It thus widens from approximately 4.5 m to a maximum width of 15 m, which is reached at a distance of approximately 10 m from the driver position.

The first ground area 210 from FIG. 3A thus essentially represents a visible area at the back, while the second ground area 220 from FIG. 3B represents a lateral visible area, which is important for a lane change, for example, in order to register, for example whether a vehicle is present in one or two lanes adjacent to the vehicle.

The second camera unit 122 (and similarly the third camera unit 123 on the driver side 16) is primarily used to acquire the first ground area 210 and simultaneously the second ground area 220.

FIGS. 4A, 4B illustrate the third ground area 230 and the fourth ground area 240, which are acquired simultaneously according to exemplary embodiments primarily by the first camera unit 121 (and similarly by the fourth camera unit 124 on the driver side 16).

FIG. 4A illustrates the third ground area 230, which extends from a third line 231, which goes through the position 15 of the driver perpendicularly to a movement direction of the utility vehicle, by 1.75 m to the rear and by approximately 1 m forward. The width of the third ground area 230 is approximately 2 m, measured from the right vehicle edge 16. The third ground area 230 for the driver side 17 is defined in an identical or similar manner.

FIG. 4B shows a fourth ground area 240, which is also acquirable by the first camera unit 121, for example. The fourth ground area 240 extends, beginning with the front side 241 of the driver cab 10, over the vehicle width up to a distance of approximately 2 m forward and up to 2 m beyond the vehicle edge 16 on the passenger side. Optionally, the fourth ground area 240 is rounded at the front right corner (from the viewpoint of the driver) with a radius of curvature of approximately 2 m.

The third ground area 230 and the fourth ground area 240 thus in particular acquire areas which are poorly or hardly visible to vehicle drivers of utility vehicles (in contrast to passenger vehicles).

To achieve the desired redundancy of the camera monitoring system, the first camera unit 121 is installed, for example, on the commercial (utility) vehicle (for example in an upper corner area of the driver cab 10 on the passenger side 16) in such a way that the first camera unit 121 can acquire the third ground area 230, the fourth ground area 240, the first ground area 210, and the second ground area 220. To be able to visually display all ground areas as realistically as possible, for example recordings of the first ground area 210 and of the second ground area 220 can be processed accordingly in order to remove possible distortions due to the wide-angle objective of the first camera unit 121.

Because of the redundancy, it is possible that the camera monitoring system replaces conventional mirrors. Even in the event of failure of one of the camera units 121, 122, . . . , it is still ensured that the driver maintains a sufficient lateral and rear-facing overview—in particular after the mentioned image transformations (for example for the image data of the first camera unit 121, in order to adapt it for the rear-facing visual acquisition). A sufficiently high resolution is advantageously to be selected for the camera units for this purpose, so that sufficiently many image details are present for areas located farther back.

The redundant image acquisition, image processing, and image display is achieved according to the present invention not only for the passenger side 16, but also on the driver side 17. The system from FIG. 2 is used for this purpose, in which two independent camera units are also provided on the driver side 17: the third camera unit 123, which sends image data to the first image processing unit 111, and the fourth camera unit 124, which sends image data to the second image processing unit 112. Even if a failure occurs in these components, it can still be ensured by the intact subsystem that image data can be displayed via the corresponding display (for example due to the independent image processing units). On the driver side, the fourth camera unit 124 is also a wide-angle or fisheye camera, which also acquires image data, however, which are suitable after corresponding transformation for acquiring the first and second ground area 210, 220 and visually displaying them to the driver in as undistorted a manner as possible. For this purpose, the fourth camera unit 124 can again be attached in an upper corner area of the driver cab of the utility vehicle, so that this camera unit can acquire not only the third ground area 230 and the fourth ground area 240 (in front of the driver cab), but also the rear-facing first ground area 210 and the second ground area 220.

The first camera unit 121 and the fourth camera unit 124 can be formed identically, for example, and can merely be fastened at different positions on the driver cab. The second camera unit 122 can also be designed in the same way as the third camera unit 123 and can merely be attached on the opposite vehicle side.

Exemplary embodiments thus permit the driver to continuously monitor the occurrences both on the left vehicle side and also on the right vehicle side and to carry out a safe lane change, even for the case in which a malfunction occurs in one of the camera units 121, 122, . . . or processing units 111, 112 or displays 131, 132.

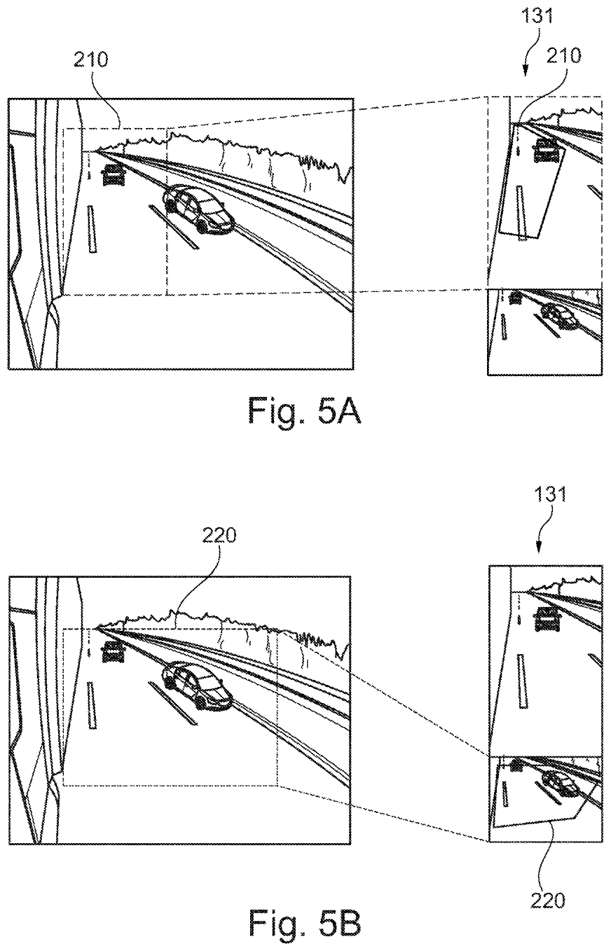

FIG. 5A and FIG. 5B show by way of example an acquired image from the driver side (on the left side) and an associated display in the corresponding first display unit 131 (on the right side). In FIG. 5A, the first ground area 210 is highlighted as an example, which is shown, for example in an upper area of the display in the first display unit 131. FIG. 5B shows the second ground area 220, which is shown, for example on the first display unit 131 in a lower area.

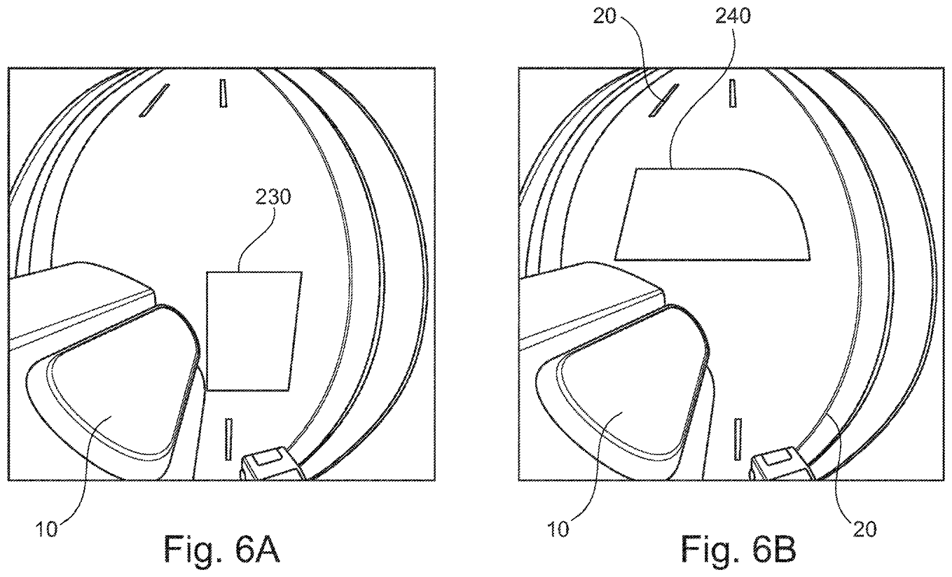

FIG. 6A shows by way of example an acquired image having the highlighted third ground area 230, as is acquired by the first camera unit 121 on the passenger side 16. FIG. 6B shows by way of example the fourth ground area 240, as is acquired, for example by the first camera unit 121 from the passenger side 16. Both acquired ground areas 230, 240 can be visually displayed in a similar manner as the first ground area 210 and the second ground area 220 (see FIGS. 5A, 5B).

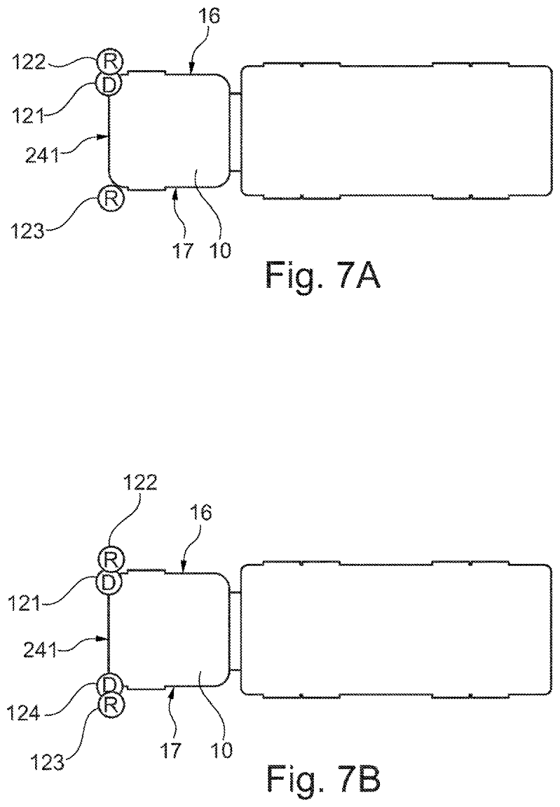

FIG. 7A shows by way of example the attachment of the camera units 121, 122, . . . at various positions on the cab 10 of the utility vehicle. The first camera unit 121 is installed here together with the second camera unit 122 in a front corner area on the passenger side 16. The third camera unit 123 is fastened in a front corner area on the driver side 17 of the driver cab 10.

FIG. 7B shows an attachment of the camera units for the exemplary embodiment from FIG. 2. For this purpose, in addition to the camera units 121, 122, 123 shown in FIG. 7A, the fourth camera unit 124 is also fastened in a front corner area on the driver side 17 on the driver cab 10. It is possible due to the illustrated fastenings in the front corner area that the acquired ground areas are acquired by different camera units. The image data are thus redundant (at least for the first ground area 210, the second ground area 220, and the fourth ground area 240) and the system is error resistant.

Essential aspects of the exemplary embodiments of the present invention can be summarized as follows:

The camera system provides redundant image acquisition at least for the passenger side of a vehicle, so that a failure of one component does not result in a total failure of the system and the driver can register the lateral and back area in spite of an error. For this purpose, the architecture comprises, for example, two rear-facing cameras or camera units 122, 123, which can each be attached in front corner areas of the driver cab 10 (for example as a replacement for conventional mirrors) and acquire a sufficiently large field of view to be able to visually display multiple areas laterally to and behind the vehicle. Moreover, a camera 121 oriented downward is provided, which has, for example a wide-angle objective or a fisheye lens and is attached at least to the passenger side 16, in order to be able to cover multiple acquisition areas (ground areas) there in an overlapping manner.

Two types of cameras are advantageously also provided on the driver side 17, a wide-angle camera 124 to cover a lower area adjacent to and/or in front of the driver cab 10, and a camera 123 oriented to the rear. Moreover, the system comprises at least two display units 131, 132 for the driver, which are advantageously provided on each side of the driver cab 10 and visually display the camera images. Moreover, the system comprises at least two independent image processing units 111, 112, which are connected to independent power supply units 141, 142, wherein each image processing unit 111, 112 evaluates a part of the camera data and activates a corresponding display unit 131, 132.

The at least two image processing units 111, 112 process the camera images in such a way that at least the passenger side 16 of the vehicle permits redundant coverage at least for the back area of the utility vehicle. For this purpose, for example, one of the two camera systems is conducted to one display and image data of the other camera system to the other display, which additionally each have a separate power supply.

Finally, the image processing units 111, 112 can be connected to one another via a data line 115 in order to exchange image data. This is advisable in particular if one of the systems fails, so that the acquired image data can automatically be displayed on the other system by the other display. The security in the visual acquisition of the environment of the utility vehicle is thus significantly increased.

Exemplary embodiments of the present invention also relate in particular to the following subjects.

A system for replacing rearview mirrors for utility vehicles having an error safeguard, characterized by at least one redundant camera monitoring system for the passenger side of the vehicle.

According to further advantageous embodiments, in the system the redundant camera monitoring system comprises at least one rear-facing camera in one circuit and a downward-facing fisheye camera in the other circuit, wherein each of the two cameras acquires two sensor areas on the passenger side and both circuits are connected to a data connection in order to enable independence of the display.

According to further advantageous embodiments, in the system the redundant camera monitoring system comprises at least one further rear-facing camera (which acquires two sensor areas on the driver side), which is integrated in the same circuit as the downward-facing fisheye camera.

According to further advantageous embodiments, a redundant camera monitoring system is also provided in the system on the driver side.

According to further advantageous embodiments, in the system the redundant camera monitoring system comprises at least one rear-facing camera in one of the circuits (which acquires two sensor areas on the driver side) and a downward-facing fisheye camera (which acquires at least two sensor areas on the driver side) in the other circuit, wherein the circuits are connected to one another via a data connection in order to offer independent di splay options.

According to further advantageous embodiments, the front side of the vehicle is also acquired by a redundant camera system in the system.

According to further advantageous embodiments, in the system the redundant camera monitoring system comprises at least two downward-facing fisheye cameras (each of which acquires the sensor area in front of the vehicle), which are separately connected to the two circuits, wherein the circuits are connected to one another via a data connection in order to enable an independent display.

A method for determining an error in a camera monitoring system for utility vehicles additionally comprises an algorithm which is applied to the image data in order to obtain a deviation of the image acquisition (for example a frozen image) for overlapping sensor areas. In case of a determined deviation, the affected circuit (or circuitry) is deactivated accordingly and the corresponding image data are displayed for the driver by the remaining intact system.

This method is used to determine whether a malfunction is present in one of the subcomponents of the camera monitoring system. In response to such fault behavior, the acquired image data are accordingly relayed differently within the system and provided to the driver there.

The method can also be computer implemented, i.e., it can be implemented by instructions which are stored on a storage medium and are capable of executing the steps of the method when it runs on a processor. The instructions typically comprise one or more instructions which can be stored in different ways on different media in or peripheral to a control unit (having a processor) and which, when they are read and executed by the control unit, cause the control unit to execute functions, functionalities, and operations which are necessary to execute a method according to the present invention.

The features of the invention disclosed in the description, the claims, and the figures can be essential for the implementation of the invention both individually and also in any combination.

### LIST OF REFERENCE NUMERALS

10 driver cab

15 driver position (eye positions)

16 passenger side (vehicle edge on passenger side)

17 driver side

20 roadway markings

111,112, . . . image processing units

115 data connection

121,122, . . . camera units

131, 132 separate display units

141, 142 separate power supply units

210, 220, . . . lateral area

211, 121, . . . front reference lines (first line, second line, . . . )

241 front vehicle edge/vehicle boundary

1.-15. (canceled)

16. A camera monitoring system for at least one lateral area on a passenger side of a commercial vehicle, comprising:
a first image processing unit;
a first camera unit for acquiring image data from the at least one lateral area,
wherein the first camera unit provides the image data to the first image processing unit for processing;
a second image processing unit; and
a second camera unit for acquiring further image data from the at least one lateral area, wherein the second camera unit provides the further image data to the second image processing unit for processing,
wherein the first image processing unit and the second image processing unit are configured to process image data independently of one another in order to enable a redundant image acquisition for the at least one lateral area.

17. The camera monitoring system as claimed in claim 16, further comprising:
a third camera unit for acquiring image data from a further lateral area on a driver side of the utility vehicle, wherein the third camera unit provides the image data to the first image processing unit for processing; and/or
a fourth camera unit for acquiring image data from the further lateral area on the driver side of the utility vehicle, wherein the fourth camera unit provides the image data to the second image processing unit for processing.

18. The camera monitoring system as claimed in claim 16, further comprising:
a first display unit for displaying processed image data from the first image processing unit; and/or
a second display unit for displaying processed image data from the second image processing unit.

19. The camera monitoring system as claimed in claim 16, further comprising:
a data connection between the first image processing unit and the second image processing unit, wherein
the first image processing unit and the second image processing unit are configured to output received image data via the data connection.

20. The camera monitoring system as claimed in claim 19, wherein
the first image processing unit and/or the second image processing unit are configured to execute at least one of the following functions:
comparing image data from overlapping acquisition areas and, based thereon, determining an error of the camera monitoring system;
carrying out an image transformation of image data from the first camera unit, the second camera unit, the third camera unit and/or the fourth camera unit to reduce distortions in horizontal image areas;
identifying roadway markings in the image data from the first camera unit, the second camera unit, third camera unit and/or the fourth camera unit to assist lane tracking.

21. The camera monitoring system as claimed in claim 17, wherein
the first camera unit has a fisheye objective to simultaneously acquire a front area in front of the commercial vehicle and the at least one lateral area on the passenger side upon attachment to a front corner area of the commercial vehicle; and/or
the fourth camera unit has a fisheye objective to simultaneously acquire the front area and the lateral area on the driver side upon attachment to a front corner area of the commercial vehicle.

22. The camera monitoring system as claimed in claim 21, wherein
the first camera unit and the fourth camera unit are each further configured to acquire ground areas in front of and adjacent to the driver cab, to thus enable a redundant acquisition of the ground area in front of the driver cab.

23. The camera monitoring system as claimed in claim 17, wherein
the lateral area and the further lateral area on the respective side comprise at least one first ground area defined as follows:
beginning with a first line, which extends perpendicularly to a movement direction of the utility vehicle and is offset to the rear by 4 m from a position of a vehicle driver, the first ground area extends to the rear with a variable width laterally in parallel to a vehicle edge, wherein the variable width increases linearly from 1 m to a width of 5 m up to a distance of 26 m from the first line and then remains constant.

24. The camera monitoring system as claimed in claim 23, wherein
the lateral area and the further lateral area on the respective side comprise a second ground area defined as follows:
beginning with a second line, which extends perpendicularly to a movement direction of the utility vehicle and is offset to the rear by 1.5 m from a position of a vehicle driver, the second ground area extends to the rear to a length of 23.5 m with a variable width laterally in parallel to a vehicle edge, wherein the variable width increases linearly from 4.5 m to a width of 15 m up to a distance of 8.5 m from the second line and then remains constant.

25. The camera monitoring system as claimed in claim 24, wherein
the lateral area and the further lateral area on the respective side comprise a third ground area defined as follows:
beginning with a third line, which extends perpendicularly to a movement direction of the utility vehicle through a position of a vehicle driver, the third ground area extends 1.75 m to the rear and 1 m forward at a width of 2 m in parallel to a vehicle edge.

26. The camera monitoring system as claimed in claim 25, wherein the front area comprises a fourth ground area defined as follows:
beginning with a front vehicle boundary, the fourth ground area extends up to at least 2 m in front of a total width of the driver cab and laterally 2 m beyond the passenger side.

27. A commercial vehicle comprising a camera monitoring system as claimed in claim 16.

28. A method for determining an error of a camera monitoring system for at least one lateral area on a passenger side of a commercial vehicle, the system comprising:
a first image processing unit;
a first camera unit for acquiring image data from the at least one lateral area,
wherein the first camera unit provides the image data to the first image processing unit for processing;
a second image processing unit; and
a second camera unit for acquiring further image data from the at least one lateral area, wherein the second camera unit provides the further image data to the second image processing unit for processing,
wherein the first image processing unit and the second image processing unit are configured to process image data independently of one another in order to enable a redundant image acquisition for the at least one lateral area,
the method comprising:
comparing image data for overlapping image areas, which were acquired by different camera units; and
determining the error in the camera monitoring system based on the comparison.

29. The method as claimed in claim 28, wherein
the comparison comprises at least one of the following:
determining a non-correspondence of the overlapping image areas;
determining a frozen image which was acquired by one of the camera units;
transforming image data to reduce distortions of fisheye objectives or wide-angle objectives.

30. A computer product comprising a non-transitory computer readable medium having stored thereon program code which, when executed on a processor, carries out the acts of:
determining an error of a camera monitoring system for at least one lateral area on a passenger side of a commercial vehicle, the system comprising:
a first image processing unit;
a first camera unit for acquiring image data from the at least one lateral area,
wherein the first camera unit provides the image data to the first image processing unit for processing;
a second image processing unit; and
a second camera unit for acquiring further image data from the at least one lateral area, wherein the second camera unit provides the further image data to the second image processing unit for processing,
wherein the first image processing unit and the second image processing unit are configured to process image data independently of one another in order to enable a redundant image acquisition for the at least one lateral area,
wherein the error is determined by:
comparing image data for overlapping image areas, which were acquired by different camera units; and
determining an error in the camera monitoring system based on the comparison.
